(19) United States
(12) Patent Application Publication
(10) Pub. No.: US 2014/0186649 A1
(43) Pub. Date: Jul. 3, 2014

(54) COATED ARTICLE AND METHOD FOR MANUFACTURING THE SAME

(71) Applicants: SHENZHEN FUTAIHONG PRECISION INDUSTRY CO., LTD., (US); FIH (HONG KONG) LIMITED, Kowloon (HK)

(72) Inventor: REN-BO WANG, Shenzhen (CN)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 13/873,429

(22) Filed: Apr. 30, 2013

(30) Foreign Application Priority Data
Dec. 27, 2012 (CN) 2012105779041

(51) Int. Cl. B23K 26/34; B23K 26/36

(52) U.S. Cl. CPC B23K 26/34; B23K 26/367
USPC 428/601; 427/597; 427/556

(57) ABSTRACT

A coated article includes a metal substrate, a number of recesses defined in the metal substrate, and a plurality of sealing portions filled in the recesses. The sealing portions include metal, silicon oxide, aluminum oxide, sodium oxide, potassium oxide, and inorganic oxide pigment. The metal includes aluminum. A method for manufacturing the coated article is also provided.

### BACKGROUND

1. Technical Field

The present disclosure relates to a coated article, and a method for manufacturing the coated article.

2. Description of Related Art

An enamel coating having a pattern may be formed on a metal substrate by the following steps: a mask fixture or an adhesive tape is provided; portions of the metal substrate are covered by the masking fixture or adhesive tape; an enamel coating is sprayed on the metal substrate; and the masking fixture or adhesive tape is removed from the metal substrate. Since the enamel coating is deposited under high temperature, the masking fixture or adhesive tape are required to possess a high temperature resistance, which increases manufacturing costs. Furthermore, it can be difficult to precisely form the enamel coating.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary coated article and method for manufacturing the coated article. Moreover, in the drawings like reference numerals designate corresponding parts throughout the several views. Wherever possible, the same reference numbers are used throughout the drawings to refer to the same or like elements of an embodiment.

FIG. 1 is a cross-sectional view of an exemplary embodiment of a coated article.

FIG. 2 is a cross-sectional view of a metal substrate having a plurality of recess defined therein.

FIG. 3 is a schematic view of a CO₂ laser.

FIG. 4 is a cross-sectional view of the metal substrate of FIG. 2 having a plurality of sealing portions filled in the recess.

### DETAILED DESCRIPTION

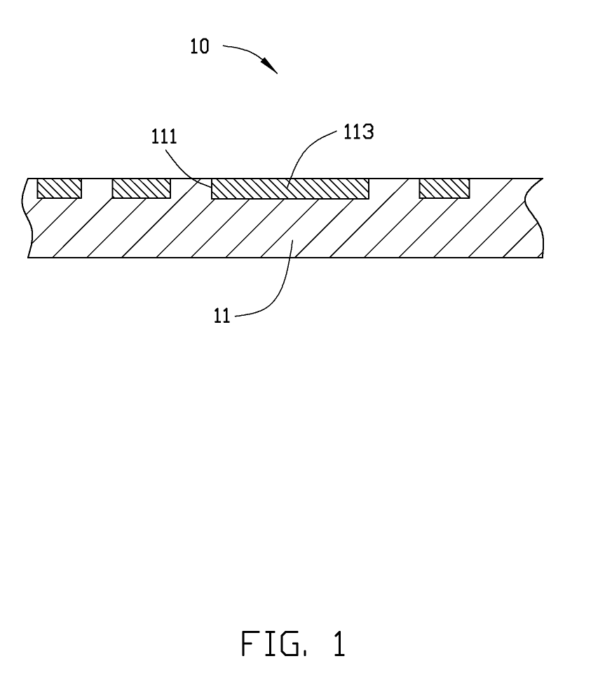

FIG. 1 shows a coated article 10 according to an exemplary embodiment. The coated article 10 includes a metal substrate 11, a plurality of recesses 111 defined in a surface of the metal substrate 11, and a plurality of sealing portions 113 filling the recesses 111. The sealing portions 113 collectively form a pattern, a character, or a logo. Each sealing portion 113 has a color different from the other.

The metal substrate 11 is made of stainless steel or titanium alloy.

Each sealing portion 113 has a thickness of about 0.15 mm to about 0.35 mm.

The sealing portion 113 contains metal element, silicon oxide, aluminum oxide, sodium oxide, potassium oxide, and inorganic oxide pigment, wherein the mass percentage of the metal element is about 10% to about 18%, the mass percentage of the silicon oxide is about 45% to about 63%, the mass percentage of the aluminum oxide is about 6% to about 11%, the mass percentage of the sodium oxide is about 5% to about 11%, the mass percentage of the potassium oxide is about 4% to about 11%, and the mass percentage of the inorganic oxide pigment is about 2.5% to about 6%. The inorganic oxide pigment includes ferric oxide, calcium oxide, cobalt oxide, or titanium oxide. If the metal substrate 11 is made of stainless steel, the metal element of the sealing portions 113 includes ferric element and aluminum element. If the metal substrate 11 is made of titanium alloy, the metal element of the sealing portions 113 includes titanium and aluminum.

A method for manufacturing the coated article 10 at least includes the following steps:

The metal substrate 11 is provided. The metal substrate 11 is made of stainless steel or titanium alloy.

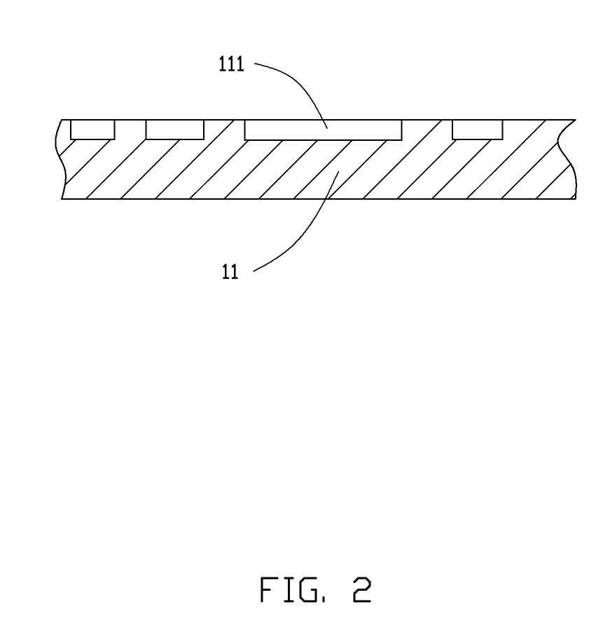

FIG. 2 shows that the metal substrate 11 is chemically etched or laser engraved to form the recesses 111. The recesses 111 cooperate to form a pattern, a character, or a logo.

A composite enamel powder is provided. The composite enamel powder includes enamel powder, metal powder, and inorganic oxide pigment. The enamel powder includes silicon oxide, aluminum oxide, sodium oxide, and potassium oxide. The inorganic oxide pigment includes ferric oxide, calcium oxide, cobalt oxide, or titanium oxide. In the composite enamel powders, the mass percentage of the silicon oxide is about 55% to about 70%, the mass percentage of the aluminum oxide is about 8% to about 12%, the mass percentage of the sodium oxide is about 6% to about 8%, the mass percentage of the potassium oxide is about 5% to about 8%, the mass percentage of the metal powder is about 8% to about 12%, and the mass percentage of the inorganic oxide pigment is about 3% to about 5%. The grain-size of the enamel powder is about 1 micrometer (pm) to about 5 μm. In the embodiment, the metal powder is aluminum powder. The grain-size of the aluminum powder is about 2 μm to about 5 μm. The grain-size of the inorganic oxide pigment is about 1 μm to about 5 μm.

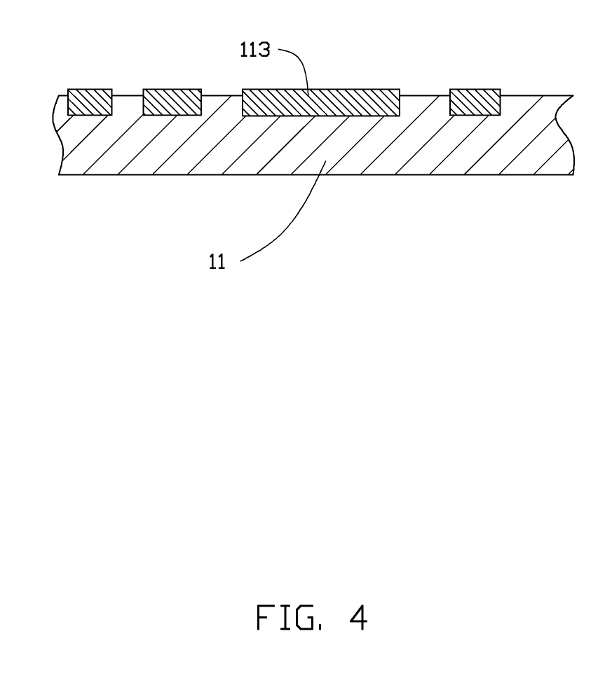

FIG. 4 shows that the composite enamel powder is laser cladded into the recesses 111 of the metal substrate 11 to form the sealing portions 113. The sealing portions 113 form a pattern, a character, or a logo.

The laser cladding process includes at least the following steps:

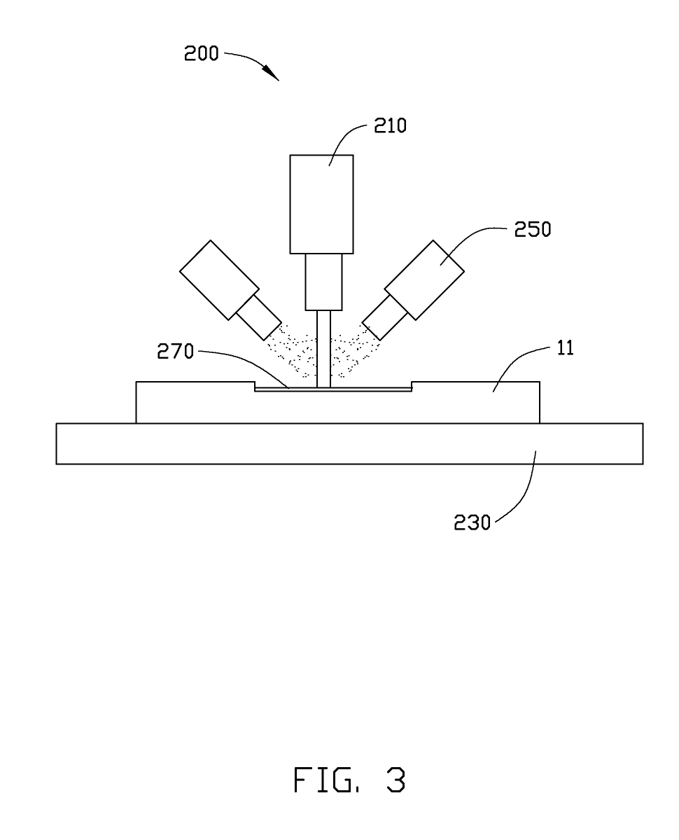

A CO₂ laser 200 is provided (see FIG. 3). The CO₂ laser includes a laser head 210, a worktable 230 located under the laser head 210, and two automatic feeding devices 250 disposed on opposite sides of the laser head 210.

The metal substrate 11 is placed on the worktable 230. The metal substrate 11 is pre-heated by a first leaser beam emitted by the laser head 210. Then the metal substrate 11 is laser engraved by a second laser beam emitted by the leaser head 210 to melt portion of the metal substrate 11 to form a molten pool 270.

The frequency of the second laser beam is about 690 Hz, the power of the second laser beam is about 4.5 kW to about 6 kW, and the scanning rate of the second laser beam is about 7.24 mm/s to about 8.43 mm/s The molten pool 270 has a depth of about 0.03 mm to about 0.125 mm. The CO₂ laser further includes a control panel (not shown). The control panel sets the scanning path of the first laser beam and the second laser beam. In the embodiment, the first laser beam and the second laser beam scan the metal substrate 11 along the path of the recesses 111.

The composite enamel powder is blasted into the molten pool 270 and melted by the second laser beam. After the second laser beam moves away, the melted metal within the molten pool 270 is evenly mixed with the melted composite enamel powder, then solidifying and crystallizing quickly to form the sealing portions 113. The angle between the automatic feeding equipment 250 and the second laser beam is about 30° to about 60°. The follow rate of the composite enamel powder is about 400 g/min to 650 g/min. Each sealing portion 113 has a thickness of about 0.2 mm to about 0.4 mm.

Alternatively, during the laser cladding process, the sealing portions 113 can present different colors by feeding inorganic oxide pigments with different colors into the recesses 111.

If the metal substrate 11 is made of stainless steel, the metal element of the sealing portions 113 includes ferric element and aluminum element, wherein the ferric element is derived by the stainless steel melted by the second laser beam. If the metal substrate 11 is made of titanium alloy, the metal element of the sealing portions 113 includes titanium element and aluminum, wherein the titanium element is derived by the titanium alloy melted by the second laser beam.

The sealing portions 113 are ground or polished to be coplanar with the metal substrate 11. After being ground or polished, each sealing portion 113 has a thickness of about 0.15 mm to about 0.35 mm.

The scanning path of the first laser beam and the second laser beam can be precisely controlled by the CO₂ laser 200 without using any masking, thus improving the accuracy of the pattern formed by sealing portions 113.

The aluminum powder of the composite enamel powder can make the melted metal in the molten pool 270 mix evenly with the melted composite enamel powder, thus providing a maximum toughness to the sealing portions 113 and decreasing the contractibility of the sealing portions 113.

It is to be understood, however, that even through numerous characteristics and advantages of the exemplary disclosure have been set forth in the foregoing description, together with details of the system and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A coated article comprising:
a metal substrate;
a plurality of recesses defined in a surface of the metal substrate; and
a plurality of sealing portions filling the recesses; the sealing portions comprising:
metal, silicon oxide, aluminum oxide, sodium oxide, potassium oxide, and inorganic oxide pigment; the metal comprising aluminum element.

2. The coated article of claim 1, the metal further comprising ferric element or titanium element <if using wherein, then use comprises; without wherein, then use comprising—this just sounds more natural>.

3. The coated article of claim 2, wherein in the sealing portions, the mass percentage of the metal is about 10% to about 18%, the mass percentage of the silicon oxide is about 45% to about 63%, the mass percentage of the aluminum oxide is about 6% to about 11%, the mass percentage of the sodium oxide is about 5% to about 11%, the mass percentage of the potassium oxide is about 4% to about 11%, and the mass percentage of the inorganic oxide pigment is about 2.5% to about 6%.

4. The coated article of claim 3, wherein the inorganic oxide pigment comprises: ferric oxide, calcium oxide, cobalt oxide, or titanium oxide.

5. The coated article of claim 1, wherein each sealing portion has a thickness of about 0.15 mm to about 0.35 mm.

6. The coated article of claim 5, wherein each sealing portion has a color different from the other sealing portions.

7. The coated article of claim 1, wherein each recesses has a depth of about 0.15 mm to about 0.35 mm.

8. The coated article of claim 1, wherein the metal substrate is made of stainless steel or titanium alloy.

9. A method for manufacturing the coated article comprising:
providing a metal substrate;
defining a plurality of recesses in a surface of the metal substrate;
providing a composite enamel powder, the composite enamel powder comprising:
enamel powder, metal powder, and inorganic oxide pigment; and
laser cladding the composite enamel powder into the recesses of the metal substrate to form the sealing portions; the sealing portions comprising: metal, silicon oxide, aluminum oxide, sodium oxide, potassium oxide, and inorganic oxide pigment; the metal comprising aluminum element.

10. The method for manufacturing the coated article of claim 9, wherein in the composite enamel powder, the mass percentage of the silicon oxide is about 55% to about 70%, the mass percentage of the aluminum oxide is about 8% to about 12%, the mass percentage of the sodium oxide is about 6% to about 8%, the mass percentage of the potassium oxide is about 5% to about 8%, the mass percentage of the metal powder is about 8% to about 12%, and the mass percentage of the inorganic oxide pigment is about 3% to about 5%.

11. The method for manufacturing the coated article of claim 10, wherein the grain-size of the enamel powder is about 1 μm to about 5 μm.

12. The method for manufacturing the coated article of claim 10, wherein the grain-size of the inorganic oxide pigment is about 1 μm to about 5 μm.

13. The method for manufacturing the coated article of claim 9, wherein the metal powder is aluminum powder.

14. The method for manufacturing the coated article of claim 13, wherein the grain-size of the aluminum powder is about 2 μm to about 5 μm.

15. The method for manufacturing the coated article of claim 9, wherein the laser cladding process comprises the following steps: providing a laser head; pre-heating the metal substrate by a first leaser beam emitted by the laser head; laser engraving the metal substrate by a second laser beam emitted by the leaser head to melt portion of the metal substrate to form at least one molten pool; blasting the composite enamel powder into the at least one molten pool and melting the composite enamel powder by the second laser beam; after the second laser beam moves away, the melted metal within the molten pool is mixed with the melted composite enamel powder to form the sealing portions.

16. The method for manufacturing the coated article of claim 15, wherein the frequency of the second laser beam is about 690 Hz, the power of the second laser beam is about 4.5 kW to about 6 kW, and the scanning rate of the second laser beam is about 7.24 mm/s to about 8.43 mm/s

17. The method for manufacturing the coated article of claim 16, wherein the follow rate of the composite enamel powder is about 400 g/min to 650 g/min.

18. The method for manufacturing the coated article of claim 15, wherein the molten pool has a depth of about 0.03 mm to about 0.125 mm.
